(19) United States
(12) Patent Application Publication
(10) Pub. No.: US 2025/0033000 A1
(43) Pub. Date: Jan. 30, 2025

(54) PROCESS FOR OBTAINING REDUCED GRAPHENE OXIDE MEMBRANES, REACTOR FOR CARRYING OUT SAID PROCESS, REDUCED GRAPHENE OXIDE MEMBRANES OBTAINED FROM THIS PROCESS AND THEIR USES IN A SEPARATION PROCESS

(71) Applicants: PETRÓLEO BRASILEIRO S.A. - PETROBRAS, Rio de Janeiro (BR); INSTITUTO PRESBITERIANO MACKENZIE, São Paulo (BR)

(72) Inventors: RODRIGO SUHETT DE SOUZA, Rio de Janeiro (BR); CAMILA MARCHETTI MARONEZE, São Paulo (BR); RICARDO DE ARAUJO CID DA SILVA, Rio de Janeiro (BR); MARCOS ALVES DOS SANTOS, São Paulo (BR); CECILIA DE CARVALHO CASTRO E SILVA, São Paulo (BR); SERGIO HUMBERTO DOMINGUES, São Paulo (BR); LEANDRO HOSTERT, São Paulo (BR); MARCUS VINICIUS DE PAIVA, São Paulo (BR); MATHEUS SANTOS DIAS, São Paulo (BR); HALINE BACHMANN PINTO, Rio de Janeiro (BR)

(21) Appl. No.: 18/763,577

(22) Filed: Jul. 3, 2024

(30) Foreign Application Priority Data
Jul. 25, 2023 (BR) BR 1020230148930

(51) Int. Cl. B01D 71/02; B01D 67/00; B01D 69/02; B01D 69/10; C02F 1/44

(52) U.S. Cl. CPC B01D 71/0211; B01D 67/00416; B01D 67/0044; B01D 69/02; B01D 69/107; C02F 1/44; B01D 2323/081; B01D 2323/10; B01D 2323/14; B01D 2323/219; B01D 2323/42; B01D 2325/04; B01D 2325/24

(57) ABSTRACT

The present invention refers to a process for obtaining reduced graphene oxide (rGO) porous membranes, homogeneous, without cracks, using very low quantities of graphene oxide (GO) nanosheets, highly adhered to the porous support and with high mechanical stability. The obtained rGO membranes present high quality and excellent operational efficiency and can be used in applications involving separation of ionic, molecular and biological species in liquid and gaseous phases, such as the treatment of water and industrial effluents and/or gas purification. Furthermore, the present invention also describes an ideal reactor to make it possible to obtain said reduced graphene oxide membranes obtained by the process described herein.

### FIELD OF THE INVENTION

The present invention refers to a process for obtaining reduced graphene oxide (rGO) porous membranes, homogeneous, without cracks, using very low quantities of graphene oxide (GO) nanosheets, highly adhered to the porous support and with high mechanical stability. The rGO membranes obtained present high quality and excellent operational efficiency and can be used in applications involving separation of ionic, molecular and biological species in liquid and gaseous phases, such as the treatment of water and industrial effluents and/or gas purification. Furthermore, the present invention also describes an ideal reactor to make it possible to obtain said reduced graphene oxide membranes achieved by the process described here.

In the present invention, within the term “graphene oxide” (GO), used herein, are included nanostructures consisting of a single layer (monolayer), arrangements of different dimensions (size and thickness of the layers), with different degrees of oxidation and variable C/O ratio.

### BACKGROUNDS OF THE INVENTION

Global water scarcity is a problem that has continually worsened due to several factors such as population growth, intense industrialization and severe climate change. Another problem is the contamination of aquatic environments, which serve as a source of safe drinking water, such as rivers and lakes, with pollutants originating from municipal sewage, industrial effluents and agricultural activities.

Furthermore, the management of complex industrial wastewater, such as that from the oil and gas industries, has also become a major challenge. This is because this sector produces large quantities of wastewater, originating both from the extraction process and refineries, which are generally characterized by high concentrations of oil and dissolved solids, with a high potential for fouling and difficult to treat.

Current osmosis technologies for water treatment are mostly based on polymeric membranes. Despite the high separation capacity and operation over a wide pH range, they present important technical limitations such as low resistance to chlorine, the formation of biofilms (microorganisms) on the surface and low energy efficiency (Bodzek, M. et al. (2020), Nanotechnology in water and wastewater treatment. Graphene—the nanomaterial for next generation of semipermeable membranes, Critical Reviews in Environmental Science and Technology, 50 (15)). This all leads to high operational costs and the need to change and/or maintain the system very frequently.

Recently, important scientific advances arising from discoveries involving two-dimensional (2D) nanomaterials, especially graphene and its derivatives, have led to the development of several technologies aimed at separation processes (Joshi, R. et al. (2014), Precise and ultrafast molecular sieving through graphene oxide membranes, Science, 343 (6172), 752-754; Werber, J. et al. (2016), Materials for next-generation desalination and water purification membranes, Nature Reviews Materials, 1 (5), 16018). As an example, the observation of the rapid permeation of water molecules through graphene oxide (GO) membranes indicated a great potential for the application of this nanomaterial in nanofiltration and desalination processes. The channels that form between the stacked “sheets” of graphene oxide allow water molecules to cross the membrane, but prevent the passage of ions and other solutes, in a mechanism similar to that of the pores in the structure of a traditional polymeric membrane.

Despite the considerable progress achieved in separation processes using GO membranes, in terms of rapid water permeation, good chemical resistance and adjustable selectivity, the hydrophilic character of GO laminates inevitably results in the intercalation of 2-3 layers of water molecules between the individually stacked sheets. This swelling effect increases the spacing between layers, allowing ions or molecules with a hydrated radius ≤0.45 nm to pass through the nanochannels (Joshi, R. et al. (2014). Precise and ultrafast molecular sieving through graphene oxide membranes. Science, 343 (6172), 752-754). Additionally, the disintegration of the membrane due to the delamination of GO nanosheets and their redispersion in water is another challenge to be overcome (Ych, C. et al. (2015). On the origin of the stability of graphene oxide membranes in water, Nature Chemistry, 7 (2), 166-170).

Several strategies have been adopted to inhibit swelling and overcome the hydration force of the GO membranes in water, which increases the spacing between layers. Covalent cross-linking has proven to be an efficient tool to obtain membranes with greater stability, broader functionalities and adjustable porosity (Yang, J. et al. (2018). Self-Assembly of Thiourea-Crosslinked Graphene Oxide Framework Membranes toward Separation of Small Molecules. Advanced Materials, 30(16), 1705775). The intercalation of K+ ions (Chen, L. et al. (2017), Ion sieving in graphene oxide membranes via cationic control of interlayer spacing, Nature, 550(7676)) and conjugated polycyclic cations (toluidine blue) (Wang, Z. et al. (2021), Graphene oxide nanofiltration membranes for desalination under realistic conditions. Nature Sustainability, 4(5)) was reported as another way to modulate interlayer spacing with significant improvements in filtration performance. The physical confinement of GO laminates incorporated in a polymer matrix (epoxy) (Nair, R. et al. (2012). Unimpeded permeation of water through helium-leak-tight graphene-based membranes, Science, 335(6067)) also proved to restrict swelling of the membrane when exposed to water, resulting in a high salt rejection (97%) for the aqueous NaCl solution.

A simpler approach that has been described to control the spacing and minimize swelling of GO membranes consists of the partial reduction of graphene oxide (Li, Y. et al. (2019). Thermally reduced nanoporous graphene oxide membrane for desalination, Environmental Science and Technology, 53(14)), converting the same into reduced graphene oxide (rGO). The removal of the oxygenated species simultaneously decreases the hydrophilicity and size of the hydrated functional groups, which remain in the nanosheets, narrowing the distance between the layers in the membrane and suppressing the hydration tendency.

The GO reduction reaction can be carried out with the nanomaterial dispersed in solution, prior to preparing the membrane, but this process generally results in flocculation of the nanosheets and a lack of control over the final microstructure (Stankovich, S. et al. (2007). Synthesis of graphene-based nanosheets via chemical reduction of exfoliated graphite oxide, Carbon, 45(7), 1558-1565), with a non-uniform stacking of the segregated rGO laminates and the presence of cracks (Ali, A. et. al (2020). Laminar Graphene Oxide Membranes Towards Selective Ionic and Molecular Separations: Challenges and Progress, Chemical Record, 20(4)), which compromise the membrane performance in a filtration process.

A more efficient strategy may be the in situ reduction of the GO membrane, in a subsequent step to the process of stacking or deposition of the GO layers on a substrate of interest. This procedure has been carried out, for example, via heat treatment (Li, Y. et al. (2019). Thermally reduced nanoporous graphene oxide membrane for desalination. Environmental Science and Technology, 53(14)), chemical reduction (Liu, H. et al. (2015). Facile fabrication of freestanding ultrathin reduced graphene oxide membranes for water purification. Advanced Materials, 27(2), 249-254) or ultraviolet irradiation (Sun, P. et al. (2015). Highly efficient quasi-static water desalination using monolayer graphene oxide/titania hybrid laminates, NPG Asia Materials, 7(2)), in different experimental configurations.

The efficiency of the reduction process varies from method to method and depends on factors such as temperature, reduction potential of the reducing agent, process duration, etc. However, when using conditions that allow a high degree of GO reduction, the structural stability of the membrane can be compromised at the end of the process, with frequent detachment of the rGO membrane from the substrate (support). Thus, under these conditions, there is unfeasible its subsequent application in separation processes, such as osmotic systems, in which the membrane structure is subjected to large pressure gradients, and the support is of fundamental importance to assist in stabilization.

Therefore, the development of efficient processes to promote the in situ reduction of graphene oxide (GO) membranes on various porous supports, such as cellulose and derivatives, nylon, alumina, PVDF, or others, is of fundamental importance for the application of rGO membranes in separation processes, such as water and effluent purification.

Among the documents of the state of the art that have already addressed the problem, the following patent references are cited, for example:

CN110127672, filed by Zhengzhou Tobacco Research Institute of CNTC, was published on Aug. 16, 2019 and describes the preparation of reduced graphene oxide films using solvothermal or hydrothermal methods. This patent concerns the preparation of films, not the preparation of membranes. This fact is relevant, since a thin film is defined as an impermeable layer of one material deposited on another, while a membrane is defined as a layer of a material that is or can be intended to absorb or segregate a liquid. The processes described therein, when applied to the production of rGO membranes, can result in a possible detachment of the membrane from the porous support, in addition to obtaining non-homogeneous surfaces, with the presence of fissures (cracks).

In contrast, the present invention developed a process for obtaining rGO membranes, which are reduced through the use of a reactor that operates at ambient pressure. Furthermore, the rGO-based membranes obtained by the present invention are highly homogeneous due to the specific use of the reactor developed in this proposal, as the reactor only exposes the surface of the membrane to hydrazine vapor, protecting a small extension of the edges, providing high physical stability to the rGO membrane (high mechanical strength and degree of adhesion to the substrate).

US20160303518A, filed by KOREA RES INST CHEMICAL TECH, was published on Oct. 20, 2016 and describes a nanocomposite ultrafiltration membrane with a polymeric matrix (polyacrylonitrile-PAN), and rGO as a filtration membrane. This document differs from the present invention because, regardless of the methodology used to prepare the material, as well as the substrates used as support, it is important to highlight that there is a great structural difference between a pure material and a composite.

EP3229945B1, filed by MONASH UNIVERSITY, was published on Oct. 14, 2020 and describes a method for producing asymmetric graphene oxide (GO) membranes to be used in nanofiltration processes for liquids and gases, species with size molecular between 200-800 Da. The issue of additional chemical and/or physical treatment to remove oxygenated functional groups from the GO structure, thus obtaining a reduced graphene oxide (rGO) membrane, had also already been addressed in this same patent, as well as the use of the hydrazine as a chemical reducing agent to form an rGO film.

However, the present invention differs from this reference by (i) using a reactor to carry out the in situ reduction of the GO membrane, with hydrazine vapor, at ambient pressure (configuring an easy-to-operate and low-cost device), giving rise to the rGO membrane; and (ii) obtain crack-free, continuous and homogeneous rGO membranes (which completely block the transport of NaCl ions, for at least 12 h—the period evaluated), from GO dispersions with a concentration of 0.23 mg/mL.

CN104876215, filed by HUAZHONG UNIVERSITY OF SCIENCE AND TECHNOLOGY, was published on Feb. 9, 2015 and describes a reduced aqueous dispersion of graphene oxide and a method of preparing the same. The reduced aqueous dispersion of graphene oxide comprises cellulose nanocrystals.

However, this reference differs from the present invention in that its entire process occurs in solution, where in a reaction vessel, the aqueous dispersion of GO is added, followed by the addition of the aqueous dispersion of nanocrystalline cellulose and the addition of an agent reducer in liquid phase, in this case aqueous hydrazine solution, under heating, stirring and reflux, between 20 minutes and 24 hours.

Therefore, given the difficulties present in the state of the art mentioned above, there is a need to develop a process to promote the in situ reduction of graphene oxide (GO) membranes with hydrazine vapor, in which the chemical reduction reaction can be carried out under different experimental conditions (reducing agent concentration and temperature) in a closed system, in which the previously prepared GO membrane is fixed.

The process described herein enables the production of high quality reduced graphene oxide (rGO) membranes with excellent operational efficiency for application in separation processes of ionic, molecular and biological species, in liquid and gaseous phases, such as treatment of water and industrial effluents and/or gas purification.

The process described herein has advantages over the state of the art, for example, obtaining homogeneous, stable and crack-free rGO membranes, using very low quantities of GO nanosheets, with high adhesion to the porous substrate (support), and with the possibility of controlling the properties of the final material (rGO) in terms of the degree of reduction and porosity. Such characteristics define the type of application and performance of the filter structure for different analytes, with different chemical characteristics and sizes, and also for different liquid media (water and/or other solvents) and gas mixtures.

### SUMMARY OF THE INVENTION

The present invention describes a process for obtaining porous reduced graphene oxide (rGO) membranes, using hydrazine vapor in previously prepared graphene oxide membranes, in a container (reactor) with support for fixing the membranes.

The present invention also describes an ideal reactor to make it possible to obtain said reduced graphene oxide membranes achieved by the process described herein.

The present invention further describes homogeneous porous reduced graphene oxide (rGO) membranes, which are obtained by the process described herein, which are crack-free, with high quality and excellent operational efficiency.

Finally, the present invention describes the use of these porous reduced graphene oxide (rGO) membranes in separations of ionic, molecular and biological species, in liquid and gaseous phases, such as in the treatment of water and industrial effluents and/or gas purification.

### BRIEF DESCRIPTION OF THE FIGURES

In order for the invention to be more easily understood, the Figures numbered 1 to 5, which accompany this specification and are an integral part thereof, are presented by way of illustration, but without the intention of limiting the invention.

FIG. 1 presents a general illustrative scheme of the process for obtaining reduced graphene oxide (rGO) membranes of the present invention.

FIG. 2 illustrates the side view (2A) of the system manufactured to perform in situ reduction with hydrazine vapor and an expanded view (2B) of all components of the support for fixing the membrane. In FIG. 2A: 1=membrane support and 2=glass tube. In FIG. 2B: 3=cover; 4=screws; 5=upper base; 6=top gate; 7=membrane; 8=bottom gate; 9=lower base; 10=nuts; and 2=tube.

FIG. 3 presents spectra in the infrared region of membranes made of GO, TrGO (180° C., 30 min) and reduced with hydrazine vapor, HGO and HTrGO (0.8 mL N2H4 (90%), 95° C., 5 min).

FIG. 4 presents a photographic image (4A) showing a reduced graphene oxide (rGO) membrane obtained by the process described in the present invention, and scanning electron microscopy images (4B) of the surface of the GO membrane and of the rGO membranes after the thermal reduction process (TrGO) and chemical reduction with hydrazine vapor (HGO and HTrGO).

FIG. 5 presents (i) a schematic illustration (5A) of the ionic diffusion cell used to test the performance of the membranes, as well as (ii) a graph (5B) of the conductivity curves as a function of time, which illustrates the ability of membranes to block the passage of Na+ and Cl− ions.

### DETAILED DESCRIPTION OF THE INVENTION

In general terms, the present invention describes a process for obtaining simple and low-cost reduced graphene oxide (rGO) membranes, in which the reduction step is carried out in situ, on previously-prepared graphene oxide membranes (GO).

What differentiates the process of the present invention from existing processes é the innovative configuration of the reactor and operational parameters that allow obtaining rGO membranes with a high degree of reduction, stable, homogeneous, without cracks, using very low quantities of nanosheets of GO, strongly adhered to porous substrates and with high mechanical stability.

The reduced graphene oxide (rGO) membranes produced by the process of the present invention are suitable for applications in separation processes, such as treatment and/or purification of water and industrial effluents, or other processes that make use of semi-permeable porous membranes.

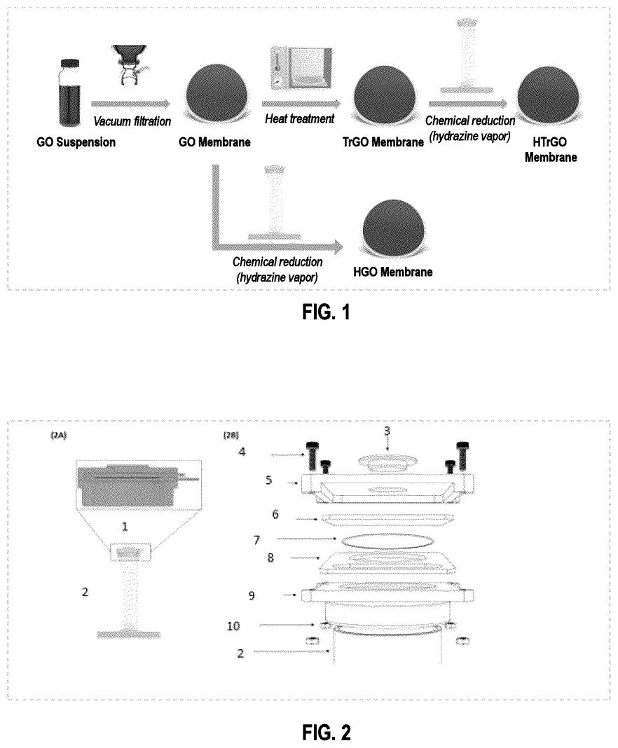

The process for obtaining reduced graphene oxide (rGO) membranes of the present invention uses the following steps, illustrated schematically in FIG. 1: Preparation of graphene oxide (GO) membrane;

Heat treatment of the GO membrane, with heating from 50° C. to 250° C., between 10 min and 720 min, resulting in membranes called herein TrGO (optional step); Chemical reduction of the GO or TrGO membrane in a reactor containing hydrazine solution, between 5° C. and 120° C., lasting between 2 min and 1440 min. The preparation of graphene oxide membranes, mentioned in step “a”, can be carried out by different processes, including, but not limited to, vacuum filtration, flexography, drop casting, spin coating, spray coating or any other technique capable of depositing stacked layers of graphene oxide on porous or non-porous substrates.

The heat treatment, described in step “b” (optional), may or may not be carried out at reduced pressures (vacuum). The atmosphere during the heat treatment may or may not consist only of air, but also of other gases or mixtures of gases such as nitrogen, argon, synthetic air, hydrogen and others. The temperature of this process can vary between 50° C. and 250° C., as well as the duration of this step can be adjusted between 10 min and 720 min.

The chemical reduction step with hydrazine, described in step “c”, can be carried out with GO membranes subjected or not to step “b” (heat treatment-optional).

The graphene oxide (GO) membrane obtained in step “c” is placed on top of a reactor consisting of a container or reaction vessel, represented by the glass tube (2), and a support (1) for the membrane fixation, as illustrated in FIG. 2.

The reactor, mentioned in step “c”, can be manufactured from glass, polymeric material, metallic material or a combination of the same.

All components of the membrane support (1) of the reactor, mentioned in step “c”, were manufactured using the PETG (polyethylene terephthalate glycol) polymer, via 3D printing, but can also be obtained by machining processes, including, but not limited to manual and automated milling and turning of other polymeric and metallic materials or combinations thereof. Fixing the membrane (6) to this support (1) is essential to avoid exposing the edge of the membrane directly to hydrazine vapor. The dimension of the lower gate (8) of the reactor membrane support (1) was designed to have a hole with a diameter ˜2 mm smaller than the diameter of the graphene oxide membrane. In this way, the edge of the membrane (6) is not exposed to the internal cavity of the reactor, remaining covered by the PETG piece.

This configuration significantly reduces the reduction of graphene oxide at the edge, preventing detachment and coiling of the membrane (6) during the chemical reduction process. A defined volume of hydrazine solution, which can be solubilized in water, ethanol, DMF or other compatible solvents, is added to the base (9) of the glass reactor (2A), and the complete system can be positioned on a heating plate, cooled or kept at room temperature. Heating the reactor accelerates the reaction and intensifies the reduction potential of the hydrazine vapor contained in the container.

The operational variables are adjusted in the following ranges: hydrazine concentration, between 0.001% and 95% by weight; temperature, between 5° C. and 120° C.; reaction time, between 2 min and 1440 min, which allows obtaining the reduced graphene oxide (rGO) membranes with different characteristics, for example, by reducing the porosity and increasing the hydrophobicity.

This versatility makes it possible to use the semipermeable rGO membranes of the present invention, with appropriate characteristics, for applications in different media (aqueous, organic and gaseous), as well as to promote separation of ionic, molecular and biological species of varying sizes.

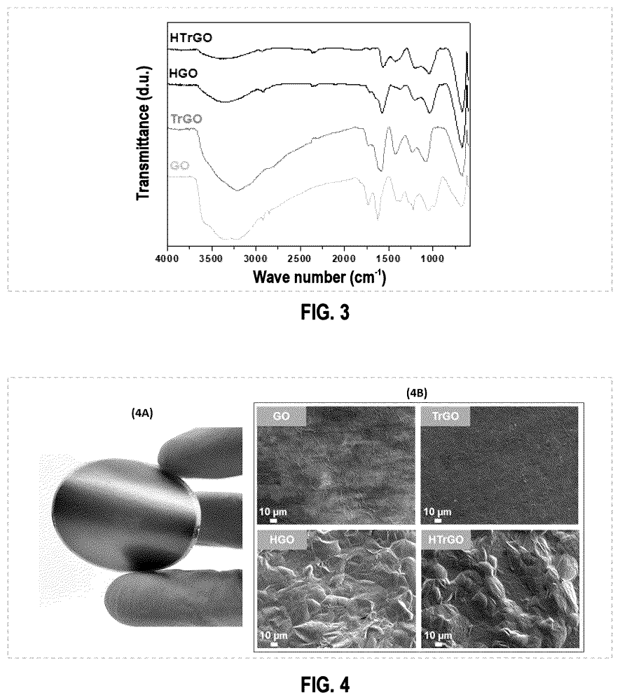

FIG. 3 shows spectra in the infrared region (FT-IR) of GO membranes, TrGO (only heat treated) membranes and membranes reduced with hydrazine vapor (HGO and HTrGO), using 800 μL of aqueous hydrazine solution 90%, at 95° C., for 5 min. The observed spectral variations prove the efficiency of the chemical reduction process, with significant removal of oxygenated groups present in the graphene oxide (GO) structure. FIG. 4 shows a photographic image (4A) of a reduced graphene oxide (rGO) membrane obtained by the process described here. It is possible to observe that the membrane remains intact after the in situ reduction process, mechanically stable, with no evidence of detachment from the porous substrate. Additionally, there are presented scanning electron microscopy images (4B) of the surface of the GO, TrGO, HGO and HTrGO membranes. Significant morphological changes are observed for samples that underwent the reduction process with hydrazine vapor (HGO and HTrGO). The reduction reaction occurs with an intense release of gases (CO2), which can result in wrinkling of the surface layers, as demonstrated.

The present invention can be better understood through the examples described below, which in no way limit the scope thereof, considering that there are possible additional alternatives.

### EXAMPLES

### Example 1—Obtaining Reduced Graphene Oxide Membrane with Hydrazine Vapor at 95° C. for 5 Min

5 mL of an aqueous suspension of graphene oxide (0.23 mg/mL) was filtered in a glass vacuum filtration system, using a nylon porous membrane (0.2 μm), 47 mm in diameter, as a support. Next, the graphene oxide membrane, deposited on the nylon substrate, was kept in a vacuum desiccator for 24 h, followed by a heat treatment for 30 min, in a preheated oven at 180° C. The heat-treated GO membrane (TrGO) was then fixed to the support illustrated in FIG. 2, with the face containing the graphene oxide directed towards the interior of the reactor. At the base (9) of the glass reactor, 0.8 mL of 90% aqueous hydrazine solution was deposited. The reactor was positioned with the base (9) touching a heating plate preheated to 95° C. (+1° C.), and maintained in this condition for 5 min. The lower gate (8) containing the membrane was then removed from the reactor and the process ended.

### Example 2—Obtaining a Reduced Graphene Oxide Membrane with Hydrazine Vapor at 22° C. for 12 H

5 mL of an aqueous suspension of graphene oxide (0.23 mg/mL) was filtered in a glass vacuum filtration system, using a nylon porous membrane (0.2 μm), 47 mm in diameter, as a support. Next, the graphene oxide membrane, deposited on the nylon substrate, was kept in a vacuum desiccator for 24 h. The dried GO membrane was then fixed to the support illustrated in FIG. 2, with the face containing the graphene oxide directed towards the interior of the reactor. At the base (9) of the glass reactor, 0.8 mL of 1% aqueous hydrazine solution was deposited. The reactor was kept at room temperature (22° C.) for 12 hours. The gate (8) containing the membrane was then removed from the reactor and the process ended.

### Example 3—Obtaining a Reduced Graphene Oxide Membrane with Hydrazine Vapor at 15° C. for 24 H

5 mL of an aqueous suspension of graphene oxide (0.23 mg/mL) was filtered in a glass vacuum filtration system, using a nylon porous membrane (0.2 μm), 47 mm in diameter, as a support. Next, the graphene oxide membrane, deposited on the nylon substrate, was kept in a vacuum desiccator for 24 h, followed by a heat treatment for 30 min in an oven preheated to 180° C. The heat-treated GO membrane (TrGO) was then fixed to the support illustrated in FIG. 2, with the face containing the graphene oxide directed towards the interior of the reactor. At the base (9) of the glass reactor, 0.8 mL of 90% aqueous hydrazine solution was deposited. The reactor was positioned in a thermostatic bath cooled to 15° C. (+1° C.), with only the base of the glass container immersed in the bath, and maintained in this condition for 24 h. The gate (8) containing the membrane was then removed from the reactor and the process ended.

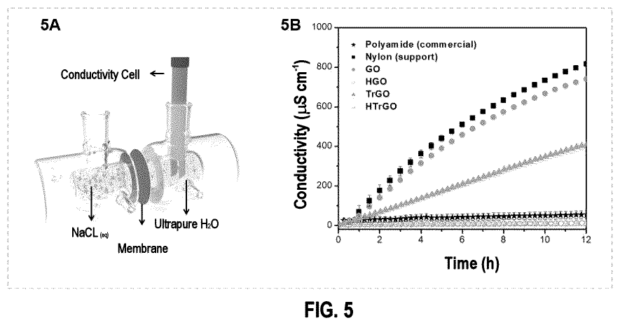

FIG. 5A shows the setup used to test the performance of reduced graphene oxide (rGO) membranes as an ionic barrier for NaCl in an aqueous medium. Performance was assessed by acquiring ionic conductivity data in the container containing ultrapure water, over time, to monitor the passage of ions through the membranes.

The ionic conductivity data collected for the GO, TrGO, HGO and HTrGO membranes are presented in FIG. 5B, along with the data for a commercial polyamide membrane, commonly used for reverse osmosis, and the porous nylon membrane used as support.

The pure GO membrane, as expected, presented the worst performance among the lamellar structures, with a profile very close to the porous nylon support. The average distance between layers in the GO stacked structure does not prevent hydrated Na+ and Cl− ions from entering the 2D nanochannels and moving through the membrane, confirming the swelling of the lamellar structure.

For TrGO, mild thermal reduction slightly increased the performance of the membrane in blocking ions, but it is still not efficient for the process of separating these ions in water.

On the other hand, both graphene oxide membranes chemically reduced by the hydrazine vapor method (HGO and HTrGO) almost completely blocked the transport of ions through the lamellar structure during the period studied (12 h). The performance was even better than that of a commercial polyamide membrane used in reverse osmosis processes.

The description that has been made so far of the present invention should be considered only as a possible embodiment, and any particular features should be understood as something that has been described to facilitate understanding. Therefore, they cannot be considered limiting of the invention, which is limited only to the scope of the claims that follow.

1. A process for obtaining a reduced graphene oxide (rGO) membrane, the process comprising:
a. preparing a graphene oxide (GO) membrane; b. optionally, heat treating the GO membrane, with heating from 50° C. to 250° C., between 10 min and 720 min, resulting in membranes named herein as TrGO; and
c. chemically reducing the graphene oxide membrane or the TrGO in a reactor containing a hydrazine solution and a support for fixing the membranes, at a temperature between 5° C. and 120° C., and for a time lasting between 2 min and 1440 min.

2. The process according to claim 1, wherein the graphene oxide membranes are made by vacuum filtration, flexography, drop casting, spin coating, spray coating, or similar.

3. The process according to claim 1, wherein the heat treatment from step “b” is carried out at reduced pressures (vacuum).

4. The process according to claim 1, wherein the process uses hydrazine solutions in step “c” in different concentrations, varying between 0.001% and 95% by weight, and
wherein the solvents are selected from the group consisting of water, alcohols, molecules with amide, amine, carbonyl, carboxyl groups, or combinations thereof.

5. The process according to claim 1, wherein the process uses graphene oxide membranes self-supported or deposited on a solid substrate, and
wherein the solid substrate comprises a polymer, a ceramic, a metal, a glass, a cellulose membrane and/or its derivatives, or a combination thereof.

6. The process according to claim 1, wherein the process uses graphene oxide (GO) membranes with thicknesses varying between 0.002 μm and 200 μm.

7. A reactor for carrying out the process of claim 1, wherein the reactor comprises: a container or a reaction vessel containing the support for fixing the graphene oxide membrane so that the membrane surface is directed towards the interior of the reactor and in contact only with vapor generated inside the container or the reaction vessel.

8. The reactor according to claim 7, wherein the container or reaction vessel is made of glass, polymeric material, metallic material, or a combination thereof.

9. The reactor according to claim 7, wherein components of the support for fixing the reactor membrane are manufactured using polyethylene terephthalate glycol (PETG) polymer via 3D printing, or manufactured by machining processes, comprising one or more of manual and automated milling and turning of other polymeric and metallic materials or combinations thereof.

10. A reduced graphene oxide (rGO) membrane obtained by the process of claim 1, wherein adjustment of the hydrazine concentration, the temperature, and the reaction time, allows semipermeable rGO membranes to be obtained with different characteristics, wherein the different characteristics comprises homogeneity, no cracks, highly adhered to the porous substrate, and high mechanical stability,
wherein the hydrazine concentration can vary from 0.001% to 95% by weight,
wherein the temperature can vary between 5° C. and 120° C., and
wherein the reaction time can vary between 2 min and 1440 min.

11. A use of the reduced graphene oxide (rGO) membrane of claim 10, wherein the use is in separation processes of ionic, molecular and/or biological species of varying sizes, in aqueous and non-aqueous liquid media and/or gaseous media, such as water and industrial effluent treatment and gas treatment and/or purification.
